(19) United States
(12) Patent Application Publication
(10) Pub. No.: US 2020/0208790 A1
(43) Pub. Date: Jul. 2, 2020

(54) COMPACT LED LIGHTING DEVICE AND METHOD FOR PRODUCING SAME

(71) Applicant: LEDVANCE GmbH, Garching bei Munchen (DE)

(72) Inventors: Georg ROSENBAUER, Wassertrudingen (DE); Wolfgang SEITZ, Eichstatt (DE); Heinz LANG, Schernfeld (DE)

(21) Appl. No.: 16/332,617

(22) PCT Filed: Sep. 12, 2017
(86) PCT No.: PCT/EP2017/072871

§ 371 Date: Mar. 17, 2020

(30) Foreign Application Priority Data
Sep. 12, 2016 (DE) 102016117107.7

(51) Int. Cl. F21K 9/235; F21K 9/232; F21V 19/00; F21V 29/70

(52) U.S. Cl. CPC F21K 9/235; F21K 9/232; F21Y 2115/10; F21V 29/70; F21V 19/0025

(57) ABSTRACT

An LED lighting device has an at least partially translucent bulb, in which an LED holder with an LED is fastened thereto. The LED holder is fastened in the at least partially translucent bulb. The LED holder has two holding elements which have a contact region for electrical connection of the LED and a connecting element outside the at least partially translucent bulb. The holding elements are used both for heat dissipation from the LED and for supplying power to the LED.

### TECHNICAL FIELD

The present invention relates to a LED lighting device, a light with at least one LED lighting device and a method for producing a LED lighting device. LED lighting devices according to the invention are suitable in particular for the construction of inexpensive but nevertheless high-quality lights, in particular for lights with a central electrical driver, with a plurality of interchangeable, low-cost LED lighting devices.

### PRIOR ART

In LED-based lights a printed circuit board is usually used with a plurality of LEDs soldered thereon, which in each case only have a low brightness. The production of such printed circuit boards is complex and requires many machines (for example soldering paste printer, automatic placement machines, reflow oven, panel separators) and therefore is often not feasible for a light manufacturer. However, the printed circuit boards are very expensive to purchase and often substantially determine the total price of the light.

Furthermore, the printed circuit board is in each case designed for only one specific light.

Due to improvements in LED development these are becoming increasingly powerful, so that fewer LEDs are needed in order to achieve the required brightness of a light. This means that an already existing printed circuit board cannot be used for the further-developed LEDs and a new printed circuit board must be developed.

Lastly, the inevitably flat (two-dimensional) shape of the printed circuit board renders the design of attractive lights with a three-dimensional arrangement of the light sources difficult if not even impossible.

Lights with three-dimensionally arranged light sources therefore often use permanently installed LEDs, which cannot be replaced. A defect of only one of the LEDs then often leads to total damage to the light.

Lastly, small models of halogen lamps (for example G4) are known, which are also used interchangeably in lights with three-dimensionally arranged light sources. Since the halogen lamps are operated with alternating current voltages, the lights are designed for this. G4 LED-based retrofit lamps must therefore have an integrated electronic driver which either—with sufficient dimensions—makes the retrofit lamps larger than the halogen lamps or—with a correspondingly smaller configuration of the electronic driver—brings with it the risk of a lower light quality (for example flickering).

### SUMMARY OF THE INVENTION

Starting from the known prior art, it is an object of the present invention to provide an improved light fixture which eliminates or at least reduces the above-mentioned disadvantages, a corresponding light as well as a corresponding method for producing the LED lighting device.

The object is achieved by a LED lighting device, a light and a method for producing a LED lighting device with the features of the independent claims. Advantageous further embodiments are set out in the subordinate claims.

A LED lighting device according to the present invention has an at least partially translucent (i.e. light-permeable, in particular transparent) bulb. The bulb preferably consists of glass, in particular quartz glass, translucent ceramic (for example Al₂O₃) or plastic. The bulb can be clear or matt (for example due to sand blasting), in particular also partially matt, for example only in the tip region. The matting can take place on the inside or the outside of the bulb.

The shape of the bulb can for example be cylindrical with an approximately hemispherical closed end. The other end can be open, so that from there the further components can be introduced into the interior of the bulb. The bulb can also have one or more further openings. The bulb preferably has an external diameter of approximately 10 mm and an internal diameter of approximately 8 mm, i.e. a wall thickness of approximately 1 mm. However, other dimensions and wall thicknesses can also be used, in particular the wall thickness does not have to be uniform over the entire bulb. The bulb can also have a different shape, for example pear-shaped or candle-shaped (i.e. the shapes known from the conventional incandescent lamps). The bulb can also have a reflector shape.

The shape of the bulb can be chosen so that the cross-sectional area of the bulb is round or oval. The cross-sectional area of the bulb can also be substantially round or oval with local deviations from this shape, for example with depressions. In particular, the cross-sectional area of the bulb can have a substantially oval configuration with two opposing depressions, i.e. it can have approximately the shape of an “8”.

In addition, optical elements can be integrated into the bulb (for example a lens by accumulation of glass in the tip). The additional optical elements in the glass bulb (in order for example to improve the light distribution) can be introduced into the glass by moulding tools (mould jaws+inflation or moulding die+impression).

At least one LED, which is fastened to a LED holder, is arranged in the interior of the bulb. If more than only one LED is to be arranged in the bulb, they can be assembled into a LED module and for example can be arranged on a printed circuit board. If reference is made below to at least one LED, this is always also understood as a LED module with more than one LED. A LED module preferably has no further electronic components apart from the LEDs and the printed circuit board.

The LED holder in turn is fastened in the bulb by a fastening means. The LED holder is designed in two parts, i.e. it has two holding elements. Each of these two holding elements has a contact region, i.e. a region for electrically contacting the LED (or of the LED module), to which it is electrically conductively connected by an electrical connection region of the LED (or of the LED module). Furthermore, each of the two holding elements has a connecting element which is arranged outside the bulb if the LED holder is installed in the bulb.

The connecting elements serve for connection to a base and as a result produce the electric connection to an electronic driver which controls the LED.

The two holding elements of the LED holder are electrically conductive and are electrically insulated from one another in the installed state (apart from the connection via the LED). As a result the holding elements can be used for the electrical connection between the LED and connecting elements and thus for the power supply of the LED. At least one or both of the holding elements is preferably made from a metal or a metal alloy, for example from copper, aluminium or a copper alloy such as brass or bronze.

The holding elements and/or the connecting element can have, completely or partially, an additional metal layer (for example tin, nickel, zinc, gold, etc.). This layer can serve for protection against corrosion and can improve both the solderability and also the visual appearance.

Holding elements made from metal can preferably be stamped parts. Alternatively, die-cast parts or MIM (metal injection moulding) parts can also be used. Electrically conductive plastics which can be produced in the injection moulding process are also conceivable.

In an embodiment of the LED lighting device at least one of the holding elements (preferably both holding elements) has (have) a heat dissipation region by which the holding element abuts the inner face of the bulb. As a result the heat generated by the LED can be efficiently discharged to the bulb and thereby to the environment. The thermal conductivity of a holding element made from metal and of a glass bulb is higher by at least one order of magnitude than the thermal conductivity of printed circuit boards used in the prior art (metal: greater than 20 W/(mK); electrically conductive plastic: approximately 5 W/(mK); glass: approximately 1 W/(mK); printed circuit board material FR4: approximately 0.2 W/(mK); printed circuit board material CEM3: approximately 1 W/(mK)). As a result, in lights having LED lighting devices according to the invention it is possible to use more powerful LEDs than in LED lights based on printed circuit boards.

For example, the LED sold by OSRAM Opto Semiconductor under the name DURIS S8 can be used as a LED in a LED lighting device according to the invention. Measurements by the inventors have revealed that in LED lighting devices according to the invention LEDs with a luminous flux of up to 300 lumen, preferably up to 200 lumen, can be used without exceeding the temperature limit values predetermined by the manufacturer.

Between the heat dissipation region of the holding elements and the bulb a material for improving the thermal conduction between holding element and bulb can be provided (thermal interface material (TIM), for example heat-conducting paste).

At least one holding element can be designed to be resilient, so that the heat dissipation region of the holding element in the installed state is pressed by the spring force against the inner face of the bulb. This also improves the heat dissipation.

In an embodiment of the LED lighting device at least one of the holding elements has a L-shaped bent strip. The L-shaped bent strip can be arranged inside the bulb so that one arm of the L extends along the wall of the bulb and the other arm of the L extends inwards approximately at right angles from the wall of the bulb. The arm which extends along the wall of the bulb can serve as heat dissipation region. The arm which extends inwards approximately at right angles from the wall of the bulb can serve as contact region to which an electrical connection region of the LED is fastened. Such a L-shaped holding element can be produced simply and without high material costs. The arm which extends along the wall of the bulb can preferably have a bend which is adapted to the internal radius of the bulb.

In an embodiment of the LED lighting device at least one of the holding elements has a cylindrical wall-shaped portion as a heat dissipation region. The contact region of the holding element is arranged as part of a cylinder base surface on one end of the cylindrical wall-shaped portion. Thus the holding element has, at least in the region in which it is introduced into the bulb, the shape of a hollow cylinder portion which is obtained by cutting a hollow cylinder with a plane extending parallel to the lateral surface of the cylinder. Such a configuration of the holding element can be produced simply as a stamped part from a metal sheet. The outer radius of the cylindrical wall-shaped section preferably corresponds to the inner radius of the bulb. In this way the heat transfer from the holding element to the bulb is optimised.

Likewise a holding element can be configured as a portion of a full cylinder as described above. If both holding elements are configured in such a way, an electrically insulating intermediate layer is preferably provided between the two full cylinder portions.

At least one holding element can also have a strip-shaped heat dissipation region, the shape of which is preferably adapted to the inner wall of the bulb. The contact region can extend inwards approximately at a right angle away from the heat dissipation region (for example at one or both of the ends of the strip-shaped heat dissipation region or in the centre thereof). The contact region can be, for example, of strip-shaped construction.

At least one of the holding elements can have a flange which is arranged outside the bulb when the holding element is introduced into the bulb. The flange is then preferably located at the edge of the opening of the bulb and as a result can serve as a limiting means during the assembly of holding element and bulb.

In an embodiment of the LED lighting device at least one of the holding elements has a pin as connecting element. The pin can be connected to the holding element, for example by soldering, welding, crimping, or the like. The pin can also be formed integrally with the holding element, for example as a pin-shaped portion of a holding element manufactured as a stamped part. With the two pins of the two holding elements of a LED lighting device this device can be inserted into a corresponding base for power supply. The two pins preferably have a diameter of approximately 0.7 mm and a spacing of approximately 4 mm.

The pins of the two holding elements serving as connecting elements can both have the same shape. In particular, both can have a circular shape or polygonal (for example rectangular) cross-section. However, both pins can also have different shapes. In particular, both pins can have a circular cross-section with different diameters or a polygonal cross-section with different dimensions. One pin can also have a circular cross-section and the other pin can have a polygonal cross-section. Such indexing can ensure, that the LED lighting device is inserted in the correct orientation into the base, above all in order to ensure the correct polarity of the connection when operating with direct current voltage. This is interesting above all if the LED lighting device can be replaced by the user. As a result also it is only possible to insert an appropriate LED lighting device (for example one adapted to the respective electronic driver) into the base.

A further parameter for the indexing is for example the spacing of the two pins, likewise in order to ensure that only appropriate LED lighting devices can be inserted into the base.

The dimensions and spacing of the pins can also correspond to those of the G4 model, i.e. pins with a circular cross-section with a diameter of 0.65-0.75 mm and a spacing of 4 mm. Then the LED lighting devices of a light according to the invention can also be replaced by known G4 retrofit lamps. In fact G4 retrofit lamps are usually designed for operation at an alternating current voltage embodied, but can also be operated at a direct current voltage.

A LED lighting device according to the invention is preferably designed for operation at a direct current voltage of 12 V. Then, for example in the event of a defect, this LED lighting device can also be replaced by a standard G4 alternating current LED retrofit lamp.

By comparison with known G4 retrofit lamps, the advantages of the LED lighting devices according to the invention are particularly apparent. For example, in the case of chandeliers (with approximately 20 lamps) or starlight ceilings (with more than 100 lamps) with the correct choice of the ballast (in the design of the light) or in the event of replacement of the ballast (in the case of already existing lights), savings can be made on a corresponding number of small electronic circuits which would have to be used in G4 retrofit lamps. This leads to a significant conservation of resources.

In an embodiment of the LED lighting device at least one of the holding elements is made from a metal or a metal alloy, for example from copper, aluminium, brass, bronze. Metal is very suitable as material for the holding elements because of its relatively high thermal conductivity and its electrical conductivity. Thus the holding elements can take on the dual function of the electrical power supply and the heat dissipation.

At least one of the holding elements is preferably manufactured as a sheet metal stamped part. This makes possible a simple and cost-effective manufacture of the holding elements. The thickness of the sheet metal can be between approximately 0.1 mm and 1 mm, preferably between approximately 0.2 mm and 0.8 mm, particularly preferably between approximately 0.4 mm and 0.5 mm.

In an embodiment of the LED lighting device at least one of the holding elements has at least one latching mark at a point facing the bulb. Accordingly the bulb can have at least one associated latching opening. The latching mark can be a projection (for example in the form of a spherical segment, i.e. an indentation) on the bulb facing outer face of the holding element (i.e. of the heat dissipation region), which can be produced for example by impression from the inner face of the holding element. The latching mark can also be formed as a tab which is connected on one side (preferably on the side facing the LED) to the holding element and extends outwards from this (towards the bulb). These embodiments of the latching mark can be simply produced during a stamping and bending process in order to produce the holding elements.

The latching opening in the bulb can be for example a hole in the bulb wall or a notch in the inner wall of the bulb. A hole in the bulb wall can be produced for example by drilling (in particular laser drilling).

The latching mark and latching opening serve to connect the LED holder (with the two holding elements) and the bulb to one another, preferably in a specific orientation relative to one another. For example, this can prevent the bulb from being released from the LED holder when a LED lighting device is removed from a lamp by pulling the bulb. During the fitting of the LED lighting device the latching mark and latching opening can prevent the LED holder from being pushed too far into the bulb.

In an embodiment of the LED lighting device the fastening means has a cylindrical (in particular hollow cylindrical) portion. The cylindrical portion is arranged inside the bulb between the two holding elements and can press them outwards against the bulb. In this way clamping can be achieved which fixes the LED holder in the bulb. If required, the effect of this clamping is assisted by the latching elements (latching mark and latching opening) discussed above. On the other hand, a fastening means with a cylindrical portion can assist the effect of the latching element, wherein for example a deflection of the holding elements inwards (away from the bulb wall and thus the latching opening) is prevented.

The fastening means with a cylindrical portion is preferably made from a material which is electrically insulating. This has the advantage that the two holding elements are not electrically connected by means of the fastening means and thus also can be used for the electrical power supply to the LED without additional insulation measures. In particular, the fastening means can be made from glass, ceramic or plastic (preferably heat-conducting).

Projections or other elements, which for example reduce or prevent rotation of the holding elements or displacement of the holding elements relative to one another, can be formed on the fastening means. For example, on the end face (bottom surface of the cylinder which is positioned nearer to the LED) one or more (in particular two) cross-pieces can be provided which prevent touching of the contact regions of the two holding elements, even if the holding elements move relative to one another, for example by a rotation of the LED holder during assembly.

Alternatively or in addition the fastening means can also have a cement, adhesive or a polymer potting compound (for example silicone, epoxy, polyurethane, etc.), by which for example the bulb is closed after the insertion of the LED holder or by which the LED holder is fastened to the inner wall of the bulb. A thermally curable adhesive can be used in particular when the bulb is made from glass, in particular from quartz glass, since then the thermal curing can take place by a hot but short thermal pulse and time-consuming curing at low temperature can be omitted.

If a cement, adhesive or a polymer potting compound is used as fastening means, it preferably expands during curing, so that the holding elements are pressed further against the bulb.

In an embodiment of the LED lighting device a portion of the bulb (preferably the portion between the LED and the closed end of the bulb) is filled with a silicone mass. The silicone mass can assist the fastening of the LED holder in the bulb. It can also improve the heat dissipation from the LED to the bulb, since the thermal conductivity of silicone (approximately 0.2-0.3 W/(Km)) is higher by approximately one order of magnitude than that of air (approximately 0.026 W/(Km)).

The silicone is preferably milky at least after the curing, so that a scattering of the light emitted by the LED is achieved. Then for example matting of the bulb can be omitted. Without such scattering of the light, depending upon the LED used, the LED lighting device can be too bright, in particular if it is visibly installed in the light.

In one embodiment of the LED lighting device there is also a support element. The LED is fastened to the support element, the support element in turn is fastened to the contact region of the holding elements. Such a support element can reduce the mechanical stress on the LED when heated (e.g. due to thermal expansion coefficients of the LED and the holding elements that are not equal) and thus prevent damage to the LED.

The support element can, for example, be an electrically insulating plate made of ceramic or plastic (e.g. polymer). The electrical connection between the electrical connection regions of the LED and the contact region of the holding elements can then be made, for example, vie a through-hole plating integrated into the support element or via conductor tracks attached to it (e.g. printed on).

Another way to prevent damage to the LED by mechanical stress during heating might be for a holding element, or at least the contact area of a holding element, to be mechanically flexible enough to deform the holding element or contact area when the LED and Holding elements expand to different degrees during heating before the LED is damaged. Preferably, the other holding element is then designed in such a way that the heat dissipation from the LED can mainly take place via this holding element.

The invention further relates to a light with one or a plurality of LED lighting devices as described above, a corresponding number of bases to receive the LED lighting devices (in particular the connecting elements of the LED lighting devices) and an electric driver for controlling the LEDs in the LED lighting devices. The individual bases (for example 2, 3, 4, 5, 6, 7, 8 or a different number of bases) can be electrically connected to one another and to the driver by cables. Thus there is no need for any printed circuit board which is costly to produce.

The LED lighting devices of the light can be arranged in a plane or also outside a plane and/or in different orientations relative to one another (three-dimensionally).

Preferably, the electrical driver is a central electrical driver, i.e. an electrical driver that supplies several LED lighting devices with electrical energy. Since not every LED lighting device has to be equipped with its own electrical driver, LED lighting devices can be manufactured cost-effectively. In particular, the LED lighting devices may be interchangeable, for example pluggable into corresponding bases of the leakage device and removable, so that in the event of a defect in one LED lighting device, it can be replaced by another operating LED lighting device.

Furthermore, the invention relates to a method for producing a LED lighting device, in particular a LED lighting device according to one of the designs described above. Accordingly, the above designs apply to the components (for example bulb, LED, LED holder, etc.) mentioned below in connection with the method of production. Likewise, the following descriptions of the components also apply to the embodiments set out above.

In a method according to the invention, first of all an at least partially translucent (in particular transparent) bulb is provided, which is preferably made from glass. In an embodiment of the method the bulb is matt, for example due to sand blasting. A LED holder with two holding elements, for example a LED holder described above, is likewise provided. Furthermore, a LED is provided. If a LED lighting device is to be produced with more than only one LED in the bulb, the LEDs can be combined into a LED module and accordingly the LED module is provided. If reference is made below to at least one LED, this is always also understood as a LED module with more than one LED. The LED or the LED module has two electrical connection regions.

The at least one LED is fastened to the LED holder, wherein in each case an electrical connection region of the at least one LED is electrically conductively connected to the contact region of the holding elements, for example by soldering.

The LED holder with the LED fastened thereto is then introduced into the bulb and is fastened in the bulb in such a way that connecting elements of the holding elements (for example connecting pins) are arranged outside the bulb.

In an embodiment of the method the provision of the LED holder comprises the stamping of the LED holder or the two holding elements of the LED holder out of a metal sheet and the bending of the stamped part into a predetermined shape.

In this case after the stamping the two holding elements of the LED holder can be connected to one another by at least one bridge. This bridge is then severed later in the method. In this way the two holding elements are electrically insulated from one another and can be used for the power supply to the LED.

The severing of the bridge can take place for example after the LED has been connected to the contact regions of the two holding elements of a LED holder. Then the two holding elements and the LED form a unit and the two holding elements no longer have to be held together by the bridge.

The severing of the bridge can also take place after the LED holder has been introduced into the bulb, in particular after the LED holder has been fastened in the bulb. The severing of the bridge can then take place for example by means of a laser, wherein a glass in the bulb (for example a bulb made from quartz glass) is drilled by the laser and then the bridge is severed through this hole.

In an embodiment of the method the LED holder remains connected to the sheet after stamping, i.e. to the material of the sheet surrounding the LED holder. The at least one LED is attached to the LED holder as long as the LED holder is connected to the sheet. The LED holder is removed from the sheet after at least one LED has been attached to the LED holder. This allows an efficient production of a large number of LED holders with LED attached to them, which can then be bent in the further process and each inserted into bulb.

In an embodiment of the method a soldering paste is applied to the contact regions of the holding elements. Then the LED can be placed with its electrical connection region to the contact regions and can be soldered there.

If the LED holder remains connected to the surrounding sheet after stamping, the solder paste can be applied to the flat sheet by screen printing, for example, and thus to a large number of LED holders at the same time. The LEDs can then be placed on the LED holders as SM (surface mounted device) elements in the pick-and-place process and soldered on in the reflow process.

In an embodiment of the method an electrically conductive adhesive is applied to the contact regions of the holding elements. Then the LED can be placed with its electrical connection region onto the contact regions and the adhesive can be cured. The curing can take place for example thermally or by means of UV light.

In an embodiment of the method the LED holder has at least one latching mark and the bulb has at least one latching opening, as has been described above. The fastening of the LED holder in the bulb then takes place by engagement of the at least one latching mark in the at least one latching opening during the insertion of the LED holder into the bulb. The latching openings in the bulb can be produced for example by laser drilling (in particular in the case of bulbs made from quartz glass).

In an embodiment of the method a fastening means (for example a fastening means with a cylindrical, in particular hollow cylindrical portion) is introduced into the bulb so that the fastening means presses at least a part of the holding elements against the bulb. As a result the LED holder is fastened in the bulb by clamping.

In an embodiment of the method the LED holder is placed on the fastener outside the bulb. The fastener is then inserted into the bulb together with the LED holder. If the internal dimensions of the bulb, the thickness of the retaining elements and the external dimensions of the fastener are dimensioned accordingly, the LED holder and the fastener are held in the bulb by clamping (frictional connection).

Alternatively or in addition a cement, adhesive or a polymer potting compound (for example silicone, epoxy, polyurethane, etc.) can be used in order to fasten the LED holder in the bulb.

In an embodiment of the method a plurality of LED holder are pre-stamped in a flat sheet in such a way that the LED holders remain connected to the sheet. Solder paste is applied to the contact regions of the LED holders (e.g. by screen printing). Each LED holder is fitted with an LED (e.g. using the pick-and-place process). The LEDs are soldered onto the LED holders (e.g. in the Reflow process). If the tow holding elements of each LED holder are connected to each other via respective LED, the LED holders are separated from the sheet (e.g. laser cutting). The LED holders can then be bent so that they can be inserted into a bulb and fixed there.

In an embodiment of the method an LED holder is stamped out of sheet metal. The two holding elements of the LED holder remain connected to each other via one, two or more bars. The LED holder is bent into the desired shape and placed on a glass tube. The glass tube can support the LED holder from the inside. Solder paste is applied to the contact regions of the holding elements (e.g. with a single dosing device or by dabbing). An LED is placed on the contact regions and soldered to the LED holder by introducing heat (e.g. by means of radiant heaters, infrared lasers, conductive heat transfer from below). The bars are removed (e.g. by laser or cutting knife). Then the LED holder can be inserted into a bulb and fastened there.

### BRIEF DESCRIPTION OF THE DRAWINGS

Preferred further embodiments of the invention are explained in greater detail by the following description of the drawings. In the drawings:

FIG. 1 shows an embodiment of a LED lighting device according to the invention;

FIG. 2 shows an embodiment of a holding element;

FIG. 3 shows an embodiment of a LED holder with a LED fastened thereto;

FIG. 4 shows a further embodiment of a LED lighting device according to the invention;

FIG. 5 shows an embodiment of a light with LED lighting devices according to the invention.

FIG. 6 shows a further embodiment of a LED lighting device according to the invention;

FIG. 7 shows an embodiment of a support element;

FIG. 8 shows a further embodiment of a LED lighting device according to the invention;

FIG. 9 shows a further embodiment of a LED lighting device according to the invention;

FIG. 10 shows a further embodiment of a support element;

FIG. 11 shows an embodiment of a fastening element.

### DETAILED DESCRIPTION OF PREFERRED EXEMPLARY EMBODIMENTS

Preferred exemplary embodiments are described below with reference to the drawings. In this case elements which are the same, similar, or act in the same way are provided with identical reference numerals in the different drawings, and repeated description of some of these elements is omitted in order to avoid redundancies.

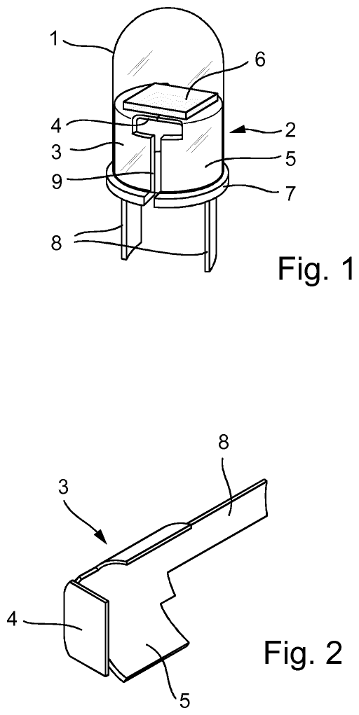

FIG. 1 shows schematically an embodiment of a LED lighting device according to the invention. The LED lighting device has a transparent glass bulb 1. A LED holder 2 which comprises two holding elements 3 is introduced into the bulb 1. Each of the holding elements 3 has a substantially flat contact region 4 and a substantially cylindrical heat dissipation region 5.

A LED 6 is permanently soldered with its electrical connection regions (in this case on the underside of the LED 6 and therefore not visible) to the contact region of the two holding elements 3. The heat dissipation regions 5 abut the inner wall of the bulb 1, so that the heat generated by the LED 6 during operation can be transmitted via the contact regions 4 and the heat dissipation regions 5 to the bulb 1 and can be discharged from there to the environment.

The LED comprises a housing in which one or more LED chips are arranged. The LED chips can be covered with a fluorescent dye, so that the LED emits white light.

Each of the holding elements 3 is provided with a flange 7 which constitutes a limitation when the LED holder 2 is pushed into the bulb 1.

Furthermore, each holding element 3 is formed integrally with a connecting element 8. The LED lighting device can be inserted into a base (not shown) by the two connecting elements 8. The two connecting elements 8 have a substantially rectangular cross-section. However, the two connecting elements 8 differ in their dimensions. Thus one of the connecting elements 8 is wider than the other. This prevents the LED lighting device from being inserted upside down into the base.

Since the two retaining elements 3 are electrically insulated from one another by an air gap 9, the power supply to the LED 6 can take place via the two holding elements 3. The holding elements simultaneously undertake the heat dissipation from the LED 6 to the bulb 1.

FIG. 2 shows schematically an individual holding element 3 of a LED holder 2. The holding element 3 has a heat dissipation region 5 which is formed substantially cylindrically and as a result is adapted to the form of a bulb 1 into which the holding element 3 is to be introduced. At one end the heat dissipation region merges integrally into a connecting element 8 which likewise has a cylindrical shape, but is narrower than the heat dissipation region 5. At the other end the heat dissipation region 5 merges integrally with a substantially right angle into a contact region 4 to which a LED 6 can be fastened.

A holding element 3 as illustrated in FIG. 2 can be produced simply and cost-effectively for example by stamping and bending of a sheet metal.

A LED holder 2 can comprise, for example, two holding elements 3 illustrated in FIG. 2. If an indexing of the connecting elements 8 is required, the connecting elements 8 of the two holding elements 3 can for example differ in their width. An LED holder can also have a first holding element 3 as shown in FIG. 2 and a second holding element different from the first holding element 3.

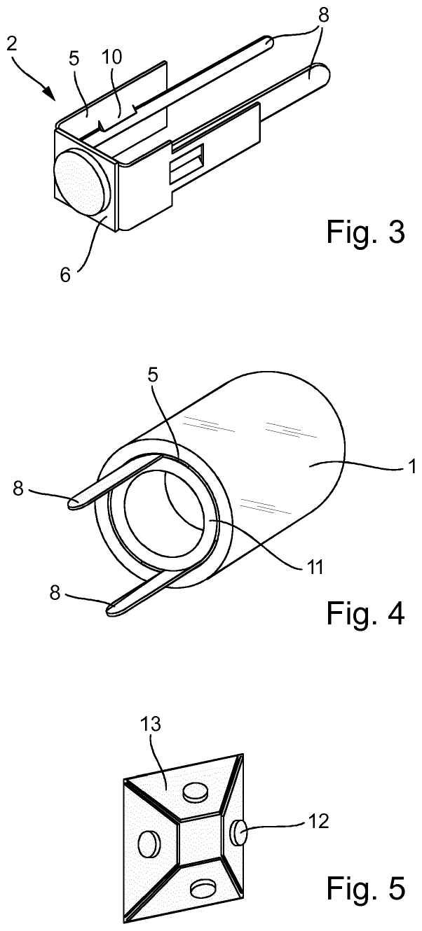

FIG. 3 shows schematically a LED holder 2 comprising two holding elements 3 with a LED 6 fastened thereto. The two holding elements 3 are in each case configured as L-shaped strips. One arm of the L constitutes the heat dissipation region 5, and the other leg constitutes the contact region 4. A LED 6 is soldered with its two electrical connection regions to the two contact regions 4.

The two heat dissipation regions 5 are in each case provided with a pin-shaped connecting element 8. In each heat dissipation region 5 two tabs 10 are stamped out, which in each case remain connected on one side to the heat dissipation region 5. The pin-shaped connecting elements 8 are clamped between the strip-shaped heat dissipation region 8 and the tabs 10. In addition the connecting elements 8 can also be connected to the holding element 3, for example, by soldering or welding. Alternatively the connecting elements 8 can also be connected directly to the holding element 3 by soldering or welding without clamping. The possible fastening options set out here can also be used in differently shaped holding elements.

The two pin-shaped connecting elements 8 differ by their thickness, so that an indexing is achieved which prevents the LED lighting device in which the LED holder illustrated in FIG. 3 is installed from being inserted upside down into a base. This ensures the correct polarity of the power supply.

A further embodiment of a LED lighting device according to the invention is shown schematically in FIG. 4 in a view from below. It can be seen how the two holding elements 3 of the LED holder 2 are pressed against the inner face of the bulb 1 by a fastening element 11. In this way the LED holder 2 is fastened in the bulb 1. The fastening element 11 has the shape of a hollow cylinder and is manufactured from ceramic or glass.

FIG. 5 shows schematically an example of a light in which four LED lighting devices 12 according to the invention are used. The light has a housing with four inclined side surfaces 13. Each of these side surfaces 13 is provided with a base (not shown), into which a LED lighting device 13 can be inserted in each case. An electric driver (not shown) which is connected by means of cable to the bases and serves for activation of the LEDs 6 in the LED lighting device 12 is accommodated in the interior of the housing.

Due to the use of the LED lighting device 12 according to the invention in the light, it is possible to install the LED lighting devices 12 in side surfaces 13 of the housing in a non-parallel manner relative to one another in each case, and as a result to obtain a three-dimensional arrangement.

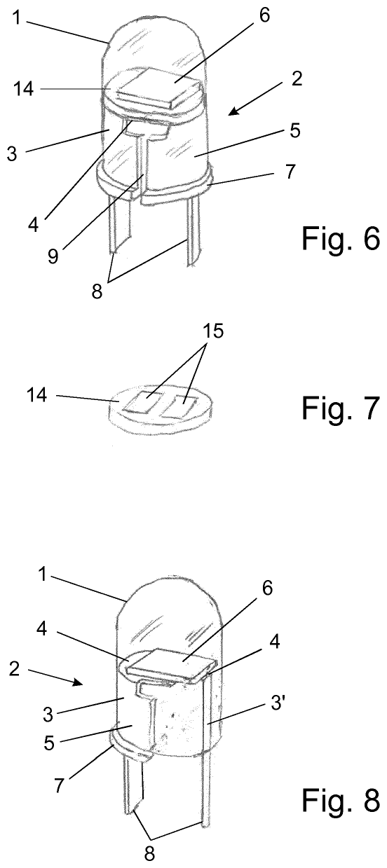

FIG. 6 shows schematically a further embodiment of an LED lighting device according to the invention. The LED lighting device shown in FIG. 6 is essentially the same as the LED lighting device shown in FIG. 1, therefor corresponding elements are not described here again. In the embodiment shown in FIG. 6, the LED 6 is not directly attached to the contact regions 4 of the holding elements 3, but the LED 6 is attached to a support element 14. The support element 14 is shown schematically in FIG. 7.

The support element 14 in turn is attached to the contact regions 4 of the holding elements 3. The electrical connection between the connection regions of LED 6 (on the underside of LED 6 and therefore not visible) and the contact regions 4 of the two holding elements 3 is made by means of vias 15 through the support element 14. The vias 15 can be electrically connected to the connection regions of the LED 6 as well as to the contact regions 4 of the holding elements 3 by soldering or gluing.

FIG. 8 schematically shows a further embodiment of an LED lighting device according to the invention. The LED lighting device shown in FIG. 8 corresponds in some aspects to the LED lighting device shown in FIG. 1, therefore the corresponding elements are not described here again. In the embodiment shown in FIG. 8, however, only one holding element 3 (as shown in FIG. 3) is used. The second holding element 3′ is mechanically flexible, which means that the holding element 3′ deforms when LED 6 and holding elements 3, 3′ expand to different degrees when heated, before LED 6 is damaged. The flexible holding element 3′ has a contact region 4, which is connected to an electrical connection area of the LED 6, and a connection element 8. The LED lighting device can be plugged into a base (not shown) with the tow connection elements 8. Heat dissipation from LED 6 in this embodiment can mainly be achieved via the rigid holding element 3.

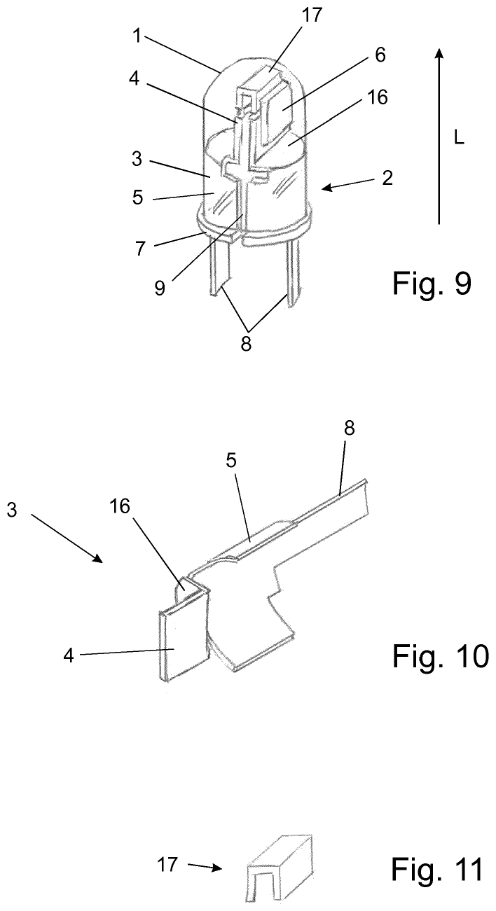

FIG. 9 schematically shows a further embodiment of an LED lighting device according to the invention. The LED lighting device has a transparent glass bulb 1. An LED holder 2 is inserted in the bulb 1 and comprises two holding elements 3. Each of the holding elements 3 has a substantially flat contact region 4 and a substantially cylindrical heat dissipation region 5. In contrast to the embodiment according to FIG. 1, the contact regions 4 here do not extend perpendicular to a longitudinal direction L, but along the longitudinal direction L. The longitudinal direction L, for example, can correspond to an axis of rotation symmetry of bulb 1.

Between the contact region 4 and the heat dissipation region 5 of each holding element 3, there extends a connection region 16, which is shown here perpendicular to the longitudinal direction L. However, the connection region 16 can also have a different orientation and can in particular be oblique to the longitudinal direction L.

Two LEDs 6 are each soldered to the contact regions 4 of the two holding elements 3 with an electrical connection region. The other electrical connection regain of each LED 6 is soldered to an electrically connection element 17, so that the two LEDs 6 are electrically connected via the connecting element 17.

The heat dissipation regions 5 are attached to the inner all of the bulb 1 so that the heat generated by the LEDs 6 during operation can be transferred to the bulb 1 via the contact regions 4, the connection regions 16 and the heat dissipation regions 5 and form there be dissipated to the environment.

Each of the holding elements 3 is provided with a flange 7, which represents a limitation when the LED holder 2 is inserted into the bulb 1.

Furthermore, each holding element 3 is formed integrally with a connecting element 8. The LED lighting device can be inserted into a base (not shown) by the two connecting elements 8. The two connecting elements 8 have a substantially rectangular cross-section. However, the two connecting elements 8 differ in their dimensions. Thus one of the connecting elements 8 is wider than the other. This prevents the LED lighting device from being inserted upside down into the base.

Since the two retaining elements 3 are electrically insulated from one another by an air gap 9, the power supply to the LED 6 can take place via the two holding elements 3. The holding elements simultaneously undertake the heat dissipation from the LED 6 to the bulb 1.

FIG. 10 schematically shows a single holding element 3 of an LED holder 2. The holding element 3 has a heat dissipation region 5 which is substantially cylindrical in shape and is thereby adapted to the shape of a bulb 1 into which the holding element 3 is to be inserted. At one end the heat dissipation region merges integrally into a connecting element 8 which likewise has a cylindrical shape, but is narrower than the heat dissipation region 5. At the other end the heat dissipation region 5 merges integrally with a substantially right angle into a connection region 16, which in turn merges into a contact region 4 to which a LED 6 can be fastened. The angel between heat dissipation region 5 and connection region 16 as well as between connection region 16 and contact region 4 can also deviate from a right angle, so that the connection region 16 is arranged particularly obliquely to head dissipation region 5 and/or contact region 4.

A holding element 3 as illustrated in FIG. 10 can be produced simply and cost-effectively for example by stamping and bending of a sheet metal.

A LED holder 2 can comprise, for example, two holding elements 3 illustrated in FIG. 2. If an indexing of the connecting elements 8 is required, the connecting elements 8 of the two holding elements 3 can for example differ in their width. An LED holder can also have a first holding element 3 as shown in FIG. 2 and a second holding element different from the first holding element 3.

FIG. 11 schematically shows an embodiment of the connecting element 17. The connecting element 17 has a U-shaped cross section and can be produced simply and cost-effectively for example by stamping and bending of a sheet metal.

However, the connecting element can also have other shapes. In particular, a connecting element can have a round U-shaped cross section instead of an angular U-shaped cross section. Alternatively, the connecting element can have a rectangular cross section, i.e. the shape of a cuboid.

Although the invention has been illustrated and described in greater detail by the depicted exemplary embodiments, the invention is not restricted thereto and other variations can be deduced therefrom by the person skilled in the art without departing from the scope of protection of the invention.

In general “a” or “an” may be understood as a single number or a plurality, in particular in the context of “at least one” or “one or more” etc., provided that this is not explicitly precluded, for example by the expression “precisely one” etc.

Also, when a number is given this may encompass precisely the stated number and also a conventional tolerance range, provided that this is not explicitly ruled out.

If applicable, all individual features which are set out in the exemplary embodiments can be combined with one another and/or exchanged for one another, without departing from the scope of the invention.

### LIST OF REFERENCES

1 bulb

2 LED holder

3 holding element

3′ flexible holding element

4 contact region

5 heat dissipation region

6 LED

7 flange

8 connecting element

9 air gap

10 tabs

11 fastening element

12 LED lighting device

13 housing side faces

14 support element

15 via

16 connection region

17 connecting element

1. An LED lighting device comprising:
an at least partially translucent bulb;
at least one LED;
an LED holder ; and
fastener for fastening the LED holder in the at least partially translucent bulb, wherein the LED holder has two holding elements, wherein each holding element has a contact region, the contact region is electrically conductively connected to an electrical connection region of one of the at least one LED and a connecting element, the connecting element located outside the at least partially translucent bulb.

2. The LED lighting device according to claim 1, wherein at least one of the holding elements has a heat dissipation region, at least one of the holding elements abuts the inner face of the at least partially translucent bulb.

3. The LED lighting device according to claim 1, wherein at least one of the holding elements has a L-shaped bent strip.

4. The LED lighting device according to claim 2, wherein the heat dissipation region of at least one of the holding elements has a cylindrical wall-shaped portion, wherein the contact region of the holding element is arranged as part of a cylinder base surface on one end of the cylindrical wall-shaped portion.

5. The LED lighting device according to claim 1, wherein at least one of the holding elements has a flange outside the at bulb.

6. The LED lighting device according to claim 1, wherein at least one of the holding elements has a pin, the pin is the connecting element which is connected to the holding element.

7. The LED lighting device according to claim 6, wherein the pin is formed integrally with the holding element.

8. The LED lighting device according to claim 1, wherein at least one of the holding elements is made from a material selected from the group consisting of a metal, a metal alloy, and a part stamped out of a metal sheet.

9. The LED lighting device according to claim 1, wherein at least one of the holding elements has a latching mark, wherein the at least partially translucent bulb has at least one latching opening.

10. The LED lighting device according to claim 1, wherein the fastener has a cylindrical portion, the cylindrical portion is arranged inside the bulb between the two holding elements and presses them outwards against the at least partially translucent bulb.

11. The LED lighting device according to claim 1, wherein the fastener a cement, an adhesive or a polymer potting compound.

12. The lighting device according to claim 1, wherein a portion of the at least partially translucent bulb is filled with a silicone mass.

13. (canceled)

14. A light comprising:
one or more LED lighting devices, the one or more LED lighting device includes
an at least partially translucent bulb,
at least one LED,
an LED holder, and
a fastener for fastening the LED holder in the at least partially translucent bulb, wherein the LED holder has two holding elements, wherein each holding element has a contact region, the contact region is electrically conductively connected to an electrical connection region of one of the at least one LED and a connecting element, the connecting element is located outside the at least partially translucent bulb;
at least one base configured to receive the LED lighting devices; and
an electrical driver for controlling the at least one LEDs in the one or more LED lighting devices.

15. A method for producing an LED lighting device, the method comprising the steps of:
fastening at least one LED to an LED holder, the LED holder includes two holding elements, an electrical connection region of the at least one LED is electrically conductively connected to a contact region of each of the two holding elements;
introducing the LED holder into an at least partially translucent bulb; and
fastening the LED holder to the at least partially translucent bulb, after fastening a connecting element of each of the holding elements is arranged outside the at least partially translucent bulb.

16. The method according to claim 15, further comprising:
stamping the LED holder out of a metal sheet; and
bending the stamped LED holder into a predetermined shape.

17. The method according to claim 16, wherein the two holding elements of the LED holder are connected to one another by at least one bridge, the method further comprises after the stamping step;
severing the at least one bridge.

18. (canceled)

19. The method according to claim 15, wherein the fastening of the at least one LED on the LED holder includes:
applying a soldering paste to the contact regions of each of the holding elements;
placing the electrical connection regions of the at least one LED onto the contact regions; and
soldering the at least one LED to the LED holder.

20. The method according to claim 15, wherein the LED holder has at least one latching mark, wherein the at least partially translucent bulb has at least one latching opening, wherein the step for fastening of the LED holder into the at least partially translucent bulb includes engaging the at least one latching mark in the at least one latching opening during the insertion of the LED holder into the bulb.

21. The method according to claim 20, further comprising:
making latching openings in the at least partially translucent bulb by laser drilling.

22. The method according to claim 15, wherein fastening the LED holder in the bulb further comprises:
introducing a fastener into the bulb, the fastener is configured to press at least a part of the holding elements against the at least partially translucent bulb.

23. (canceled)
